(19) United States
(12) Patent Application Publication
(10) Pub. No.: US 2006/0176783 A1
(43) Pub. Date: Aug. 10, 2006

(54) Apparatus for detecting saw-tooth wobbles from optical disc and method thereof

(75) Inventors: Chekcheyev Sergey, Suwon-si (KR); Tatsuhiro Otsuka, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/303,020

(22) Filed: Dec. 16, 2005

(30) Foreign Application Priority Data
Dec. 17, 2004 (KR) 2004-107809

(51) Int. Cl. G11B 7/00; G11B 5/09

(52) U.S. Cl. 369/44.13; 369/59.1; 369/47.1

(57) ABSTRACT

An apparatus for detecting wobble information of an optical disc and a method thereof are disclosed. The apparatus comprises an eliminator for outputting a second harmonic signal by eliminating subharmonic from an input wobble signal. A detector is provided for generating a cosine signal and a sine signal having a phase identical to the second harmonic signal, and detecting a phase difference of the second harmonic signal the generated signals. A compensator is provided for counting the phase difference and compensating the phase difference by shifting a phase of the cosine signal and the sine signal according to the counted value. Also, a signal output unit is provided for outputting a detection signal by multiplying the compensated cosine signal and the second harmonic signal, integrating the multiplied signal, and discriminating a signal. Accordingly, the phase error and the errors are minimized. Also, the detection accuracy increases, and the performance of detecting the saw-tooth wobble is improved.

### CROSS-REFERENCE TO RELATED APPLICATIONS

This application claims the benefit under 35 U.S.C. § 119 (a) of a Korean Patent Application No. 2004-107809 filed on Dec. 17, 2004 in the Korean Intellectual Property Office, the entire contents of which is hereby incorporated by reference.

### BACKGROUND OF THE INVENTION

1. Field of the Invention

The present invention related to an apparatus for detecting saw-tooth wobbles from an optical disc and a method thereof. More particularly, the present invention relates to an apparatus for detecting saw-tooth wobbles (SAW) from a wobble signal of an optical disc and a method thereof.

2. Description of the Related Art

Optical discs, such as digital versatile disc (DVD), include a track for locating data. The track is formed by forming a continuous guide groove on a surface of an optical disc in a form of spiral. In case of a Blu-ray disc, the guide groove has a track pitch of 320 nm.

Such a groove is deviated based on a predetermined method known in the art as a wobbling. A wobble signal is a signal detected from the wobbling. The wobble signal includes information about clock generation, timing, addresses and supplementary information for the optical disc in order to record or reproduce data read or recorded by following the track on the optical disc while the optical disc is spinning. In order to record or reproduce data, it is important to accurately and stably detect the wobble signal. In a blu-ray disc, comparatively large amount of data are recorded. In order to contain such a large amount of data, the data are recorded in a track with high data density in the blu-ray disc. Accordingly, physical address information must be accurately detected to record and reproduce data in the blu-ray disc.

Physical address information is included in wobble information of a wobble signal detected from the blu-ray disc. Such physical address information is recorded in an Address In Pre-groove (ADIP) unit based on a wobble addressing scheme using a minimum shift keying (MSK) modulation method.

In order to accurately detect physical address information from blu-ray discs, a saw-tooth wobble scheme was recently introduced. The saw-tooth wobble scheme expresses information on the blu-ray disc by transforming monotone wobble generated based on the conventional MSK modulation method to a saw-tooth wobble. That is, the saw-tooth wobble scheme forms a wobble address format by combining a saw-tooth wobble and a MSK mark with a monotone wobble.

FIG. 1 is a block diagram illustrating a wobble information detection apparatus according to the related art.

Referring to FIG. 1, the conventional wobble information detection apparatus detects a saw-tooth wobble from a wobble signal. In order to detect the saw-tooth wobble, the conventional wobble information detection device includes a multiplier 10, a phase lock loop (PLL) 20, an integrator 30, a memory 40, a comparator 50 and a zero signal generator 60.

The multiplier 10 multiplies a signal output from the PLL 20 to an input signal, that is, a wobble signal. The PLL 20 detects carrier elements from the wobble signal and outputs the detected carrier elements to the multiplier 10. The integrator 30 integrates the output signal of the multiplier 10. The memory 40 temporally stores the output signal of the integrator 30, and outputs the stored signal to the comparator 50. The comparator 50 receives an image signal from the zero signal generator 60, and compares the image signal and the stored signal received from the memory 40.

The wobble signal input to the multiplier 10 is expressed as “cos(ωt)−0.25 sin(2 ωt)” or “cos(ωt)+0.25 sin(2 ωt)” according to data value of the wobble signal representing one of 1 or 0.

A frequency of the output signal from the PLL 20 is 2ω, and the frequency of the output signal is theoretically same to a frequency of the wobble signal. However, the output signal of the PLL 20 includes harmonic elements and noises.

FIG. 2 shows wave forms of signals detected according to operations of the wobble information detection apparatus shown in FIG. 1.

Referring to FIG. 2, a graph (a) shows a waveform of an input signal of the multiplier when the input signal of the multiplier 10 is “cos(ωt)−0.25 sin(2 ωt)”. A graph (b) shows a waveform of an output signal output from the PLL 20, and a graph (c) shows a waveform of an output signal output from the multiplier 10.

The output signal of the multiplier 10 includes direct current (DC) elements and alternating current (AC) elements, but useful information are included in only the DC elements. The AC elements do not include useful information. The integrator 30 accumulates DC elements during one clock cycle and eliminates AC elements as much as possible.

The memory 40 stores a signal output from the integrator 30, and outputs the stored signal to the comparator 50. The comparator 50 outputs a comparison result after comparing the input signal and the image signal.

A performance of the conventional wobble information detection apparatus depends on noises included in the input signal and a performance of the PLL 20. That is, harmonic elements, 4ω, 6ω, 8ω, are included in the output signal of the PLL 20 with the noises, and the harmonic elements cause to generate supplementary DC elements in the output signal of the integrator 30. Such an unintended supplementary DC elements increase an error generation rate of the conventional wobble information detection apparatus.

Interference between wobble signals of adjacent tracks generates a phase difference between second harmonics. Accordingly, an absolute value of valid DC elements in the output signal of the multiplier 10 is decreased, and thus the error generation rate increases.

### SUMMARY OF THE INVENTION

Accordingly, certain exemplary embodiments of the present invention address the above-mentioned drawbacks and/or problems. An exemplary aspect of certain embodiments of the present invention is to provide an apparatus for detecting saw-tooth wobbles (SAW) from a wobble signal of an optical disc with the improved ability by lowering error rates including noise and a method thereof.

In accordance with an aspect of the present invention, there is provided a wobble information detection apparatus comprising a subharmonic eliminator for outputting a second harmonic signal by eliminating subharmonic elements from an input wobble signal, a phase difference detector for generating a cosine signal and a sine signal having a phase identical to the second harmonic signal output from the subharmonic eliminator, and detecting a phase difference of the second harmonic signal the generated signals, a phase difference compensator for counting the detected phase difference and compensating the detected phase difference by shifting a phase of the cosine signal and the sine signal according to the counted value, and a signal output unit for outputting a saw-tooth wobble detection signal by multiplying the phase compensated cosine signal and the second harmonic signal, integrating the multiplied signal, and discriminating a sign of the integrated signal.

The subharmonic eliminator may comprise a first integrator for integrating DC elements included in the input wobble signal, a subtracter for eliminating the integrated DC element from the input wobble signal by subtracting the integrated DC element from the input wobble signal, a delay for delaying the DC eliminated signal from the subtracter for a predetermined time, and an adder for eliminating a first harmonic elements by adding the DC eliminated signal from the subtracter and the delay signal from the delay.

The phase difference detector may comprise a cosine signal memory for generating the cosine signal having a frequency identical to the second harmonic signal, a first multiplier for multiplying the cosine signal and the second harmonic signal, a second integrator for integrating the outputs signals of the first multiplier, and a first latch for storing the output signal of the second integrator for a predetermined time.

The first latch may store the output signal of the second integrator for a cycle of the saw-tooth wobble.

The phase difference compensator may shift the phase of the cosine signal by counting the phase difference and inputting the count value to the cosine signal memory.

The signal output unit may output the saw-tooth wobble detection signal by multiplying the cosine signal shifted according the phase difference compensation and the second harmonic signal from the first multiplier, integrating the multiplied signals by the second integrator, storing the integrated signal in the first latch, and discriminating a sign of the output signal output from the first latch.

The phase difference detector may comprise a sine signal memory for generating the sine signal having a frequency identical to the second harmonic signal, a second multiplier for multiplying the sine signal and the second harmonic signal, a third integrator for integrating the multiplied signals fro the second multiplier, and a second latch for storing the output signal of the third integrator for a predetermine time.

The phase difference detector may further comprise a divider for dividing the output signal of the second latch by the output signal of the first latch, and a phase difference output unit for outputting an arctangent signal corresponding to the divided signal output fro the divider as the phase difference.

The phase compensator may comprise a phase lock loop (PLL) for generating a cycle signal having a frequency which is an integer time of the wobble signal, and a counter for counting the phase difference based on the cycle signal.

The saw-tooth wobble detection signal may have a binary value according to a sing of an integrated value generated by the phase difference compensated cosine signal and the second harmonic signal and integrating the multiplied signal.

In accordance with another exemplary aspect of the present invention, there is provided a method of detecting wobble information, the method comprising eliminating subharmonic elements from an input wobble signal and outputting a second harmonic signal, generating a cosine signal and a sine signal having a phase identical to the second harmonic signal, and detecting a phase difference of the second harmonic signal and the generated signals, counting the detected phase difference and compensating the detected phase difference by shifting a phase of the cosine signal and the sine signal according to the counted value, and outputting a saw-tooth wobble detection signal by multiplying the phase compensated cosine signal and the second harmonic signal, integrating the multiplied signal, and discriminating a sign of the integrated signal.

Eliminating subharmonic elements may comprise integrating DC elements included in the wobble signal and eliminating the integrated DC element from the wobble signal by subtracting the integrated DC element from the wobble signal.

The eliminating subharmonic elements may further comprise delaying the DC eliminated signal for a predetermined time, and eliminating a first harmonic elements by adding the wobble signal and the delayed wobble signal.

The detecting a phase difference may comprise generating the cosine signal having a frequency identical to the second harmonic signal, multiplying the cosine signal and the second harmonic signal, generating a first integrated signal by integrating the outputs signals of the first multipliers, and storing the first integrated signal for a predetermined time.

In the storing the output signal, the first integrated signal may be stored for a time corresponding to a cycle of the saw-tooth wobble.

In the outputting a saw-tooth wobble detection signal, the saw-tooth wobble detection signal may be output by multiplying the cosine signal shifted according the phase difference compensation and the second harmonic signal, generating a second integrated signal by integrating the multiplied signals, and discriminating a sign of the second integrated signal.

The saw-tooth wobble detection signal may have a binary value according to a sign of the second integrated signal.

The detecting a phase difference may comprise generating the sine signal having a frequency identical to the second harmonic signal, multiplying the sine signal and the second harmonic signal to generate a multiplied signal, generating a third integrated signal by integrating the multiplied signals, and storing the third integrated signal for a predetermine time.

The detecting a phase difference may further comprise generating a tangent signal by dividing the third integrated signal by the first integrated signal, and outputting an arctangent signal corresponding to the tangent signal as the phase difference.

The compensating the detected phase difference may comprise generating a PLL cycle signal having a frequency which is an integer time of the wobble signal; and counting the phase difference based on the PLL cycle signal.

### BRIEF DESCRIPTION OF THE DRAWINGS

The above aspects and features of the present invention will be more apparent by describing certain embodiments of the present invention with reference to the accompanying drawings, in which like reference numerals will be understood to refer to like parts, components and structures, where:

FIG. 1 is a block diagram illustrating a wobble information detection apparatus according to the related art;

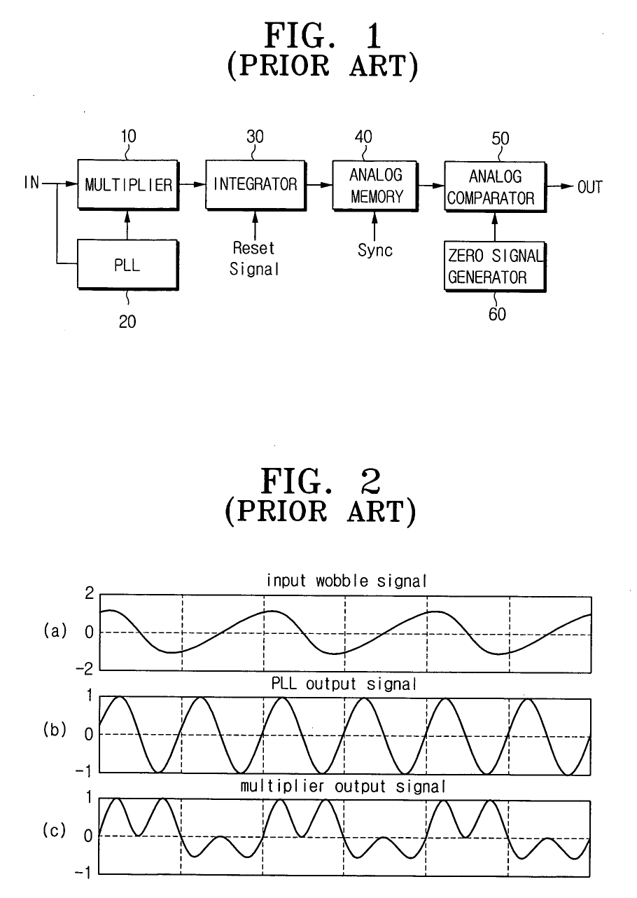

FIG. 2 shows waveforms of signals detected according to operations of the wobble information detection apparatus shown in FIG. 1;

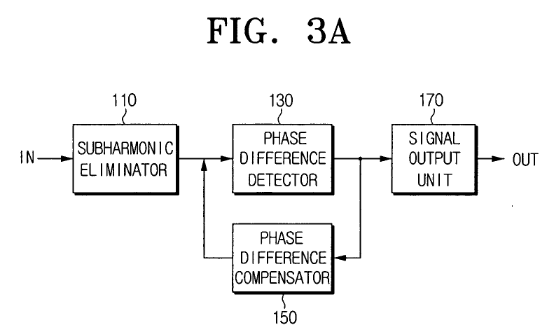

FIGS. 3A and 3B are block diagrams illustrating a wobble information detection apparatus in accordance with an exemplary embodiment of the present invention;

FIG. 4 shows waveforms generated according to operations of a wobble information detection apparatus in accordance with an exemplary embodiment of the present invention; and

FIG. 5 is a flowchart showing a method of detecting wobble information in accordance with an exemplary embodiment of the present invention.

### DETAILED DESCRIPTION OF EXEMPLARY EMBODIMENTS

Certain exemplary embodiments of the present invention will be described in greater detail with reference to the accompanying drawings.

In the following description, as noted above, same drawing reference numerals are used for the same elements throughout the drawings. The matters defined in the description such as a detailed construction and elements are exemplary, designed to assist in a comprehensive understanding of the invention. Thus, one of ordinary skill in the art will appreciate that other implementations are within the teachings of the present invention. Also, well-known functions or constructions are not described in detail for clarity and conciseness.

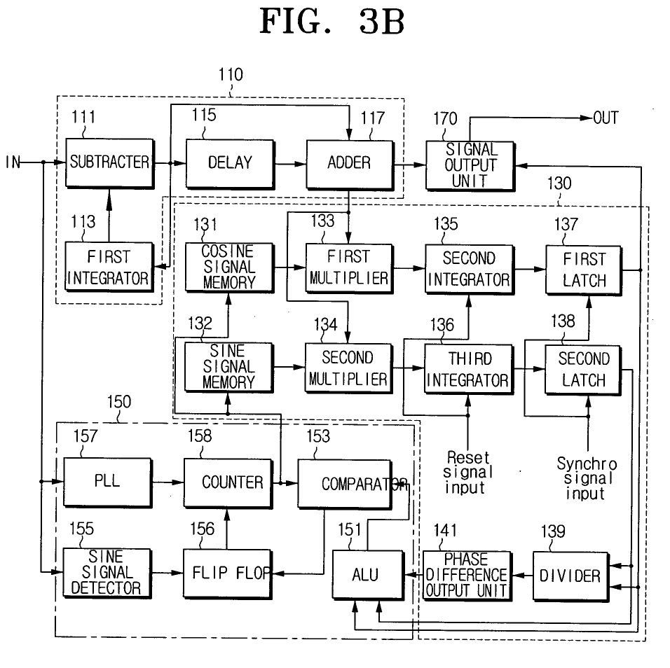

FIGS. 3A and 3B are block diagrams illustrating a wobble information detection apparatus in accordance with an exemplary embodiment of the present invention.

Referring to FIGS. 3A and 3B, the wobble information detection apparatus according to an exemplary embodiment of the present invention comprises a subharmonic eliminator 110 for eliminating direct current (DC) elements and subharmonics from an input wobble signal, and outputting harmonics. A phase difference detector 130 is provided for detecting a phase difference between a harmonic signal and a predetermined PLL signal. A phase difference compensator 150 is provided for compensating a detected signal. Also, a signal output unit 170 is provided for outputting a signal representing wobble information according to a sign of the phase compensated signal.

The subharmonic eliminator 110 includes a subtracter 111, a first integrator 113, a delay 115 and an adder 117.

The subtracter 111 receives a wobble signal. The first integrator 113 receives the wobble signal from the subtracter 111, extracts and integrates DC elements from the wobble signal and outputs the integrated signal to the subtracter 111 again. Then, the subtracter 111 subtracts DC elements from the wobble signal, and outputs the DC eliminated signal to the delay 115.

The delay 115 buffers the output signal of the subtracter 111 for a predetermined time and outputs a signal having a reverse phase to a first harmonic of the input signal to the adder 117. Then, the adder 117 receives the output signal of the subtracter 111 and the signal having reverse phase from the delay 115 and adds the two received signals to compensate the first harmonic elements of the input signal.

The phase difference detector 130 includes a cosine signal memory 131, a first multiplier 133, a second integrator 135 and a first latch 137, a sine signal memory 132, a second multiplier 134, a third integrator 136 and a second latch 138. The cosine signal memory 131, the first multiplier 133, the second integrator 135 and the first latch 137 form a first signal flow line. Also, the sine signal memory 132, the second multiplier 134, the third integrator 136 and the second latch 138 form a second signal flow line. Also, the phase difference detector 130 further includes a divider 139 and a phase difference output unit 141.

The cosine signal memory 131 previously stores necessary data to generate cosine signals with various frequencies, and generates a cosine signal having a frequency identical to the second harmonic signal output from the subharmonic eliminator 110.

The first multiplier 133 multiplies an output signal from the cosine signal memory 131 to the output signal of the adder 117. The second integrator 135 integrates output signals of the first multiplier 133, and outputs the integrated signal to the first latch 137. The first latch 137 stores the integrated signal for a saw-tooth wobble entire cycle.

The sine signal memory 132 previously stores necessary data to generate sine signals with various frequencies, and generates a sine signal having a frequency identical to the second harmonic signal output from the subharmonic eliminator 110.

The second multiplier 134 multiplies the output signal of the adder 117 and the output signal of the sine signal memory 132. The third integrator 136 integrates the output signal of the first multiplier 133, and outputs the integrated signal to the second latch 138. The second latch 138 stores the integrated signal for a saw-tooth wobble entire cycle.

The divider 139 divides a second latch output signal from the second latch 138 by a first latch output signal from the first latch 137. The divided signal is input to the phase difference output unit 141. The phase difference output unit 141 previously stores arctangent signal, and outputs arctangent signal corresponding to the input signal value. The phase difference output unit may be a memory, such as a read only memory (ROM).

The phase difference compensator 150 includes an arithmetic and logic unit (ALU) 151, a comparator 153, a reference signal detector 155, a flip flop 156, a phase lock loop (PLL) 157, and a counter 158.

The ALU 151 determines a sign and a size of a signal to be output from the phase difference output unit 141 by using output signals of the first latch 137 and the second latch 138.

The comparator 153 resets the flip flop 156 as logic 0 by generating a pulse if the output signal of the ALU 151 and the output signal of the counter 158 are identical, and resets the counter 158 at a falling edge of a signal output from the flip flop 156.

The counter 158 starts to count at a reset state. The counter 158 also receives a signal generated from the PLL 157 and counts a cycle of the signal. The signal generated at the PLL 157 is a cycle signal having a frequency divided by the input wobble signal. Accordingly, the counter 158 counts according to the cycle the generated signal at the PLL 157, inputs to the comparator 153, and transfers a count value corresponding to a phase difference output from the ALU 151 to the cosine signal memory 131 and the sine signal memory 132 to output a compensated signal, which is compensated as much as a phase difference output from the ALU 151.

The signal output unit 170 outputs a signal representing 0 or 1 by discriminating a sign of a signal output from the first latch 137. A signal input to the first latch 137 is an integrated value generated by multiplying second harmonic signal of the wobble signal to the compensated cosine signals output from the phase difference compensator 150, which are cosine signals compensated as much as a phase difference detected by the phase difference detector 130, and integrating the multiplied signals.

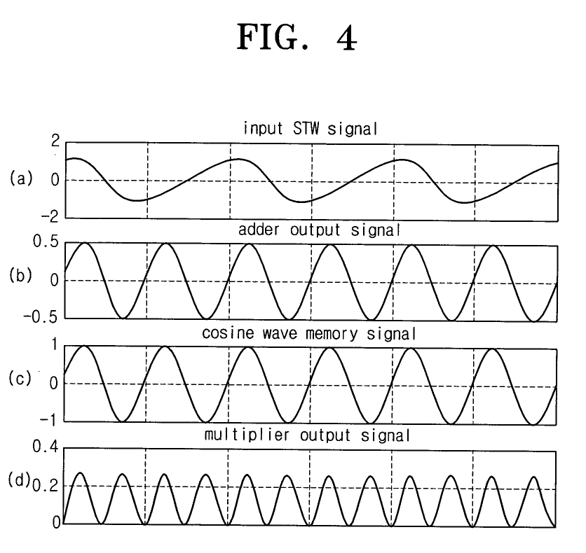

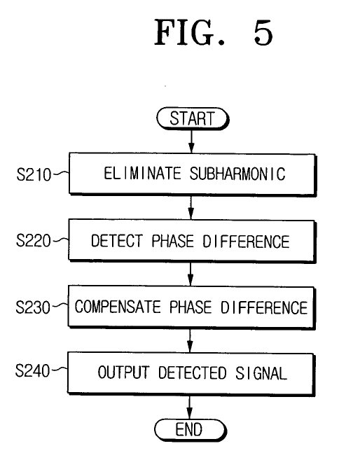

FIG. 4 shows waveforms generated according to operations of a wobble information detection apparatus in accordance with an exemplary embodiment of the present invention, and FIG. 5 is a flowchart showing a method of detecting wobble information in accordance with an exemplary embodiment of the present invention.

Referring to FIGS. 4 and 5, at first, the subharmonic eliminator 110 eliminates subharmonic elements such as DC elements and first harmonics from the input wobble signal in operation S210. A signal (a) in FIG. 4 shows a waveform of general wobble signal input to the wobble information detection apparatus. Such a wobble signal is expressed in Eq. 1 below.
(1)cos(\overline{ω}kt)−0.25 sin(2\overline{ω}kt+φ)+C, or
(2)cos(\overline{ω}kt)+0.25 sin(2\overline{ω}kt+φ)+C Eq. 1

In Eq. 1, ω denotes a frequency of a wobble signal, k is a number of sample, t is a sampling frequency cycle, φ represents a phase shift caused by errors such as interference between tracks, and C is direct current (DC) elements.

In order to eliminate the DC elements, the subtracter 111 receives the wobble signal and outputs the received wobble signal to the first integrator 113. The first integrator 113 extracts the DC elements from the wobble signal, and integrates the DC elements. The integrated DC element signal is input to the subtracter 11 again. Then, the subtracter subtracts the DC elements from the wobble signal and outputs the DC eliminated signal to the delay 115.

The DC eliminated signal of the subtracter 111 is expressed as shown in Eq. 2 below.
cos(\overline{ω}kt)+0.25 sin(2\overline{ω}kt+φ) Eq. 2

In order to eliminate the first harmonic elements, the delay 115 buffers the DC eliminated signal from the subtracter 111 for a predetermined time, outputs a signal having a reverse phase compared to the first harmonic elements of the input signal to the adder 117. The delay time of the delay 115 is π/ω. In this case, the output signal of the delay 115 is expressed as shown in Eq. 3 below.
cos(\overline{ω}(kt−π/\overline{ω}))+0.25 sin(2\overline{ω}(kt−π/\overline{ω})+φ)=−cos(\overline{ω}kt)+0.25 sin(2\overline{ω}k+φ) Eq. 3

Accordingly, the adder 117 receives the DC eliminated signal shown in Eq. 2 from the subtracter 111 and the signal having the reverse phase to the first harmonic elements shown in Eq. 3 from the delay 115, and adds the two received signal for compensating the first harmonic elements from the input signal. A signal (b) in FIG. 4 shows a waveform of the DC and first harmonic eliminated signal output from the adder 117. The DC and first harmonic eliminated signal from the adder 117 is expressed as shown in Eq. 4 below.
0.5 sin(2\overline{ω}kt+φ) Eq. 4

After eliminating the DC and the first harmonic, the phase difference detector 130 detects a phase difference between the DC and first harmonic eliminated signal input from the adder 117 and a cosign signal (or sine signal) having identical frequency to the DC and first harmonic eliminated signal in operation S220.

The cosine signal memory 131 and the sine signal memory 132 generate cosine signals and sine signals having a frequency identical to a second harmonic signal output from the subharmonic eliminator 110. A signal (c) in FIG. 4 shows a waveform of a signal output from the cosine signal memory 131. Also, the cosine signal and the sine signal output from the cosine signal memory 131 and the sine signal memory 132 are expressed as shown in Eq. 5 below.
(1)cos(2\overline{ω}kt)
(2)sin(2\overline{ω}kt) Eq. 5

The first multiplier 133 multiplies the output signal from the adder 117 and the output signal of the cosine signal memory 131, and the second integrator 135 integrates the outputs signals from the first multiplier 133. The integrated signal is input and stored in the first latch 137 for a saw-tooth wobble entire cycle. A signal (d) in FIG. 4 shows a waveform of a signal output from the first multiplier 133.

The second multiplier 134 multiplies the output signal from the adder 117 and the output signal of the sine signal memory 132, and the third integrator 136 integrates the outputs signals from the first multiplier 133. The integrated signal is input and stored in the second latch 138 for a saw-tooth wobble entire cycle.

The divider 139 generates a divided signal by dividing the output signal of the second latch 138 by the output signal of the first latch 137. The divided signal inputs to the phase difference output unit 141. The phase difference output unit 141 outputs an arctangent signal corresponding to the divided signal value. Herein, the output signals from the first multiplier 133 and the second multiplier 134 are expressed in Eq. 6 as signals (1) and (2) shown below.
(1)0.5 sin(2\overline{ω}kt+φ)cos(2\overline{ω}kt)
(2)0.5 sin(2\overline{ω}kt+φ)sin(2\overline{ω}kt) Eq. 6

Also, the signals (1) and (2) in Eq. 6 can be transformed to (1) and (2) in Eq. 7.
(1)0.25 sin φ+0.25 sin(4\overline{ω}kt+φ)
(2)0.25 cos φ−0.25 cos(4\overline{ω}kt+) Eq. 7

Accordingly, the output signals of the second integrator 135 and the third integrator 136 are expressed in Eq. 8 as (1) and (2), respectively, shown below.

$$\begin{matrix}( 1 ) {\sum }_{k = N}^{M} ( 0.25 sin ϕ + 0.25 sin ( 4 ϖ kt + ϕ ) ) \\ ( 2 ) {\sum }_{k = N}^{M} ( 0.25 cos ϕ - 0.25 cos ( 4 ϖ kt + ϕ ) )\end{matrix} \qquad Eq . 8$$

In Eq. 8, N denotes a number of sample where a saw-tooth wobble is started, and M represents a number of sample where the saw-tooth wobble is terminated. Accordingly, (M−N+1) is the number of an entire cycle of the saw-tooth wobble.

Accordingly, the output signals output from the first latch 137 and the second latch 138 are expressed in Eq. 9 as (1) and (2), respectively, shown below.
(1)0.25(M−N+1)sin φ
(2)0.25(M−N+1)cos φ Eq. 9

The output signal of the divider 139 is expressed in Eq. 10 as shown below.

$$\vert \frac{cos ϕ}{sin ϕ} \vert = \vert - \frac{sin ( ϕ + π / 2 )}{cos ( ϕ + π / 2 )} \vert = \vert tg ( ( ϕ + π / 2 ) \vert \qquad Eq . 10$$

The phase difference output unit 141 outputs the signal expressed in Eq. 11 as shown below.
arctg|tg((φ+π/2)| Eq. 11

The phase difference compensator 150 enables the cosine signal memory 131 and the sine signal memory 132 to generate the cosine signal and the sine signal having identical phase compared to the second harmonic signal output from the adder 117 by generating the cosine signal and the sine signal compensated according to the phase difference output from the phase difference detector 130 in operation S230.

In order to generating the phase compensated cosine signal and the sine signal, the ALU 151 determines a sign and a size of the output signal of the phase difference output unit 141 by using the output signals of the first latch 137 and the second latch 138. The output signal output from the phase difference output unit 141 is an absolute value signal so signs of the signals are all positive. Accordingly, the output signals of the first latch 137 and the second latch 138 are used for deciding the sign.

The signal output with the decided sign and size by the ALU 151 is shown in Eq. 12 below.
arctg|tg((φ+π/2)|/2\overline{ω}T, where α>0, β>0
(arctg|tg((φ+π/2)+π)|/2\overline{ω}T, where α<0, β<0
(−arctg|tg((φ+π/2)+π)|/2\overline{ω}T, where α<0, β>0
(−arctg|tg((φ+π/2)+2π)|/2\overline{ω}T, where α>0, β<0 Eq. 12

In Eq. 12, α is the output signal of the first latch 137 shown in Eq. 9 as (a), and β is the output signal of the second latch 138 shown in Eq. 9 as (b). Also, 2ωT is a phase difference of each sample.

The signal generated at the PLL 157 is a cycle signal having a cycle of ρω. Herein, p=2π/ωT. That is, the frequency of the signal generated in the PLL 157 is a value generated by multiplying ρto the frequency of the wobble signal.

The counter value output from the counter 158 is expressed as shown in Eq. 13 below.

$$γ ( k ) = \{ \begin{matrix}γ ( k - 1 ) + 1 , if γ ( k - 1 ) < p \\ 0 , if γ ( k - 1 ) = p\end{matrix} \qquad Eq . 13$$

Herein, γ is the output signal from the counter.

The comparator 153 compares the output signal of the counter 158 and the output signal of the ALU 151, and resets the flip flop 156 to be logic 0 by generating a pulse when the two signals are identical. The comparator 153 resets the counter 158 when the signal output from the flip flop 156 is a falling edge. The counter 158 is reset by receiving the output signal of the PLL 157 and starts to count a cycle of a signal until a next reset. Accordingly, phases of output signals from the cosine signal memory 131 and the sine signal memory 132 are shifted according to a count value for a cycle generating a reset. That is, according to an exemplary embodiment of the present invention, the cosine signal memory 131 and the sine signal memory 132 compensate the phase difference according to a count value corresponding to the phase difference output from the ALU 151.

The output signals from the cosine signal memory 131 and the sine signal memory 132, where the phases are shifted by the phase difference output unit 150, are expressed in Eq. 14 below.
(1)cos(2\overline{ω}(k−θ)T)
(2)sin(2\overline{ω}(k−θ)T) Eq. 14

Herein, θ denotes the output signal of the ALU 141 shown in Eq. 12.

The signal output unit 170 outputs a signal representing 0 or 1 by multiplying the second harmonic signal of the wobble signal to the cosine signal output from the cosine signal memory 131 compensated according to the phase difference detected by the phase difference detector 130, integrating the multiplied signals, and discriminating a sign of the output signal of the first latch 137 in operation S240.

If φ=π/6 in Eq. 1, the output signal of the adder 117 representing Eq. 4 becomes “0.5 sin(2ωkT+π/6)”, and the output signal of the phase difference output unit 141 becomes “arctg|tg(π/6+π/2)|=π/3” according to the Eq. 11.

Accordingly, since α>0, β6>0, the output signal of the ALU 20 becomes π/6ωT according to Eq. 12, and the output signal of the cosine signal memory 131, where the phase is shifted according to the phase difference compensation, is cos(2ω(k−π/6ωT)T)=cos(2ωkT−π/3)=sin(2ωkT+π/6). That is, according to an exemplary embodiment of the present invention, the output signal of the cosine signal memory 131 becomes identical to the phase of the second harmonic of the saw-tooth wobble, and the output signals of the multiplier 133 do not include negative elements as shown in FIG. 4 (d). Accordingly, errors are almost not detected in the output signal of the integrator 135.

Since a variation of detected phase difference φ is very small, a reference saw-tooth wobble and a saw-tooth wobble generated before or after the reference saw-tooth wobble have an identical phase. Accordingly, a detection method according to an exemplary embodiment of the present invention is a coherent type.

As described above, the saw-tooth detection method according to exemplary embodiments of the present invention uses the coherent type detection method using the second harmonic of the saw-tooth wobble. Therefore, bit error rate and phase error rate are lower than the conventional detection method.

As described above, in an exemplary implementation of the present invention, the coherent type detection method for squaring elements of second harmonic of wobble signal is used to detect the phase difference. Therefore, the phase error may be optimally minimized and the detection accuracy may be increased according to exemplary implementations of the present invention. Therefore, errors may be minimized and a detection performance of the saw-tooth wobble may be improved.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A wobble information detection apparatus comprising:
a subharmonic eliminator for outputting a second harmonic signal by eliminating subharmonic elements from an input wobble signal;
a phase difference detector for generating a cosine signal and a sine signal comprising a phase identical to the second harmonic signal output from the subharmonic eliminator, and detecting a phase difference of the second harmonic signal and the generated signals;
a phase difference compensator for counting the detected phase difference, and compensating the detected phase difference by shifting a phase of the cosine signal and the sine signal according to the counted value; and
a signal output unit for outputting a saw-tooth wobble detection signal by multiplying the phase compensated cosine signal and the second harmonic signal, integrating the multiplied signal, and discriminating a sign of the integrated signal.

2. The wobble information detection apparatus of claim 1, wherein the subharmonic eliminator comprises:
a first integrator for integrating DC elements included in the input wobble signal;
a subtracter for eliminating the integrated DC element from the input wobble signal by subtracting the integrated DC element from the input wobble signal;
a delay for delaying the DC eliminated signal from the subtracter for a predetermined time; and
an adder for eliminating a first harmonic elements by adding the DC eliminated signal from the subtracter and the delay signal from the delay.

3. The wobble information detection apparatus of claim 1, wherein the phase difference detector comprises:
a cosine signal memory for generating the cosine signal comprising a frequency identical to the second harmonic signal;
a first multiplier for multiplying the cosine signal and the second harmonic signal;
a second integrator for integrating the outputs signals of the first multiplier; and
a first latch for storing the output signal of the second integrator for a predetermined time.

4. The wobble information detection apparatus of claim 3, wherein the first latch stores the output signal of the second integrator for a cycle of the saw-tooth wobble.

5. The wobble information detection apparatus of claim 3, wherein the phase difference compensator shifts the phase of the cosine signal by counting the phase difference and inputting the count value to the cosine signal memory.

6. The wobble information detection apparatus of claim 5, wherein the signal output unit outputs the saw-tooth wobble detection signal by multiplying the cosine signal shifted according to the phase difference compensation and the second harmonic signal from the first multiplier, integrating the multiplied signals by the second integrator, storing the integrated signal in the first latch, and discriminating a sign of the output signal output from the first latch.

7. The wobble information detection apparatus of claim 3, wherein the phase difference detector comprises:
a sine signal memory for generating the sine signal comprising a frequency identical to the second harmonic signal;
a second multiplier for multiplying the sine signal and the second harmonic signal;
a third integrator for integrating the multiplied signals from the second multiplier; and
a second latch for storing the output signal of the third integrator for a predetermine time.

8. The wobble information detection apparatus of claim 7, wherein the phase difference detector further comprises:
a divider for dividing the output signal of the second latch by the output signal of the first latch; and
a phase difference output unit for outputting an arctangent signal corresponding to the divided signal output from the divider as the phase difference.

9. The wobble information detection apparatus of claim 1, wherein the phase compensator comprises:
a phase lock loop (PLL) for generating a cycle signal having a frequency which is integer times of the wobble signal; and
a counter for counting the phase difference based on the cycle signal.

10. The wobble information detection apparatus of claim 1, wherein the saw-tooth wobble detection signal has a binary value according to a sign of an integrated value generated by the phase difference compensated cosine signal and the second harmonic signal and integrating the multiplied signal.

11. A method of detecting wobble information comprising:
eliminating subharmonic elements from an input wobble signal and outputting a second harmonic signal;
generating a cosine signal and a sine signal comprising a phase identical to the second harmonic signal, and detecting a phase difference of the second harmonic signal and the generated signals;
counting the detected phase difference and compensating the detected phase difference by shifting a phase of the cosine signal and the sine signal according to the counted value; and
outputting a saw-tooth wobble detection signal by multiplying the phase compensated cosine signal and the second harmonic signal, integrating the multiplied signal, and discriminating a sign of the integrated signal.

12. The method of claim 11, wherein the eliminating subharmonic elements comprises:
integrating direct current (DC) elements included in the wobble signal; and
eliminating the integrated DC element from the wobble signal by subtracting the integrated DC element from the wobble signal.

13. The method of claim 12, wherein the eliminating subharmonic elements further comprises:
delaying the wobble signal for a predetermined time; and
eliminating first harmonic elements by adding the wobble signal and the delayed wobble signal.

14. The method of claim 11, wherein the detecting a phase difference comprises:
generating the cosine signal comprising a frequency identical to the second harmonic signal;
multiplying the cosine signal and the second harmonic signal to generate a multiplied signal;
generating a first integrated signal by integrating the multiplied signal; and
storing the first integrated signal for a predetermined time.

15. The method of claim 14, wherein the storing of the output signal comprises storing the first integrated signal for a time corresponding to a cycle of the saw-tooth wobble.

16. The method of claim 15, wherein the outputting of the saw-tooth wobble detection signal comprises outputting the saw-tooth wobble detection signal by multiplying the cosine signal shifted according the phase difference compensation and the second harmonic signal, generating a second integrated signal by integrating the multiplied signals, and discriminating a sign of the second integrated signal.

17. The method of claim 16, wherein the saw-tooth wobble detection signal has a binary value according to a sign of the second integrated signal.

18. The method of claim 14, wherein the detecting a phase difference comprises:
generating the sine signal comprising a frequency identical to the second harmonic signal;
multiplying the sine signal and the second harmonic signal to generate a multiplied signal;
generating a third integrated signal by integrating the multiplied signals; and
storing the third integrated signal for a predetermine time.

19. The method of claim 18, wherein the detecting a phase difference further comprises
generating a tangent signal by dividing the third integrated signal by the first integrated signal; and
outputting an arctangent signal corresponding to the tangent signal as the phase difference.

20. The method of claim 11, wherein the compensating the detected phase difference comprises:
generating a PLL cycle signal comprising a frequency which is integer times of the wobble signal; and
counting the phase difference based on the PLL cycle signal.
